(19) United States
(12) Patent Application Publication
(10) Pub. No.: US 2017/0149860 A1
(43) Pub. Date: May 25, 2017

(54) PARTIAL PREFETCHING OF INDEXED CONTENT

(71) Applicant: TENSERA NETWORKS LTD., Adanim (IL)

(72) Inventors: David Ben Eli, Modiin (IL); Daniel Yellin, Ra'anana (IL); Roee Peled, Givatayim (IL)

(21) Appl. No.: 15/427,068

(22) Filed: Feb. 8, 2017

Related U.S. Application Data
(63) Continuation-in-part of application No. PCT/IB2015/057698, filed on Oct. 8, 2015.
(60) Provisional application No. 62/065,691, filed on Oct. 19, 2014.
(60) Provisional application No. 62/302,837, filed on Mar. 3, 2016.
(60) Provisional application No. 62/441,991, filed on Jan. 4, 2017.

(51) Int. Cl. H04L 29/06; H04L 29/08

(52) U.S. Cl. CPC H04L 65/607; H04L 67/02; H04L 67/28; H04L 67/1097

(57) ABSTRACT

A method includes prefetching to a memory of a user device one or more content segments of a content item, which includes multiple content segments and an index that specifies storage locations of the content segments. The index is modified to indicate that the prefetched content segments are to be retrieved from the memory of the user device. At least part of the content item is delivered by retrieving at least some of the content segments in accordance with the modified index.

### CROSS-REFERENCE TO RELATED APPLICATIONS

This application is a continuation-in-part of PCT Application PCT/IB2015/057698, filed Oct. 8, 2015, which claims the benefit of U.S. Provisional Patent Application 62/065,691, filed Oct. 19, 2014. This application also claims the benefit of U.S. Provisional Patent Application 62/302,837, filed Mar. 3, 2016, and U.S. Provisional Patent Application 62/441,991, filed Jan. 4, 2017. The disclosures of all these related applications are incorporated herein by reference.

### FIELD OF THE INVENTION

The present invention relates generally to content delivery, and particularly to methods and systems for content prefetching.

### BACKGROUND OF THE INVENTION

Various techniques are known in the art for delivering content to user devices. For example, U.S. Pat. No. 8,601,052, whose disclosure is incorporated herein by reference, describes a method and system for performing content pre-fetching for a wireless portable computing device (PCD).

As another example, U.S. Patent Application Publication 2010/0161831, whose disclosure is incorporated herein by reference, describes a content and traffic managing system. A mobile device is connectable to users and to content providers via communication links. The system tracks various parameters over time, and schedules communication in relation to predefined or projected content responsive to user content-related behavior, user communication behavior, user external behavior, and parameters of communication links.

Some content consumed by user devices has a structured, indexed structure. For example, HTTP Live Streaming (HLS) is a protocol that specifies streaming of multimedia content, including file structures. HLS is specified, for example, in an Internet Draft of the Internet Engineering Task Force (IETF RFC) entitled “HTTP Live Streaming,” draft-pantos-http-live-streaming-14, Oct. 14, 2014, which is incorporated herein by reference.

### SUMMARY OF THE INVENTION

An embodiment of the present invention that is described herein provides a method including prefetching to a memory of a user device one or more content segments of a content item, which includes multiple content segments and an index that specifies storage locations of the content segments. The index is modified to indicate that the prefetched content segments are to be retrieved from the memory of the user device. At least part of the content item is delivered by retrieving at least some of the content segments in accordance with the modified index.

In some embodiments, the content item includes a HTTP Live Streaming (HLS) item, and the index includes a playlist of the HLS item. In an embodiment, modifying the index includes, in response to prefetching a given content segment, setting a specified storage location of the given content segment in the index to indicate the storage location of the given content item in the memory of the user device.

In a disclosed embodiment, at a given point in time the modified index includes at least a first entry that specifies a first storage location in the memory of the user device, for retrieving a first content segment that has been prefetched to the memory, and a second entry that specifies a second storage location outside the user device, for retrieving a second content segment that has not been prefetched to the memory. In an example embodiment, modification of the index is performed by a processor in the user device. In another embodiment, modification of the index is performed by a processor in a content source that hosts the content item.

In some embodiments, retrieving the content segments includes running in the user device a proxy that retrieves the prefetched content segments from the memory of the user device and retrieves non-prefetched content segments over a network. In an example embodiment, modifying the index includes, in response to prefetching a given content segment, setting a specified storage location of the given content segment in the index to point to the proxy. In another embodiment, modifying the index includes setting all specified storage locations of the content segments in the index to point to the proxy, regardless of whether the content segments have been prefetched or not.

In yet another embodiment, prefetching the content segments includes prefetching two or more content segments, which correspond to a same playback period and have different media quality levels. In still another embodiment, the content item includes multiple sets of the content segments having different media quality levels, and modifying the index includes modifying an order of appearance of the sets in the index. In a disclosed embodiment, prefetching the content segments includes prefetching one or more initial content segments, which correspond to a beginning of the content item and have the highest and lowest media quality levels appearing in the index.

In some embodiments, retrieving the content segments includes, in response to a request to consume a content segment, retrieving from the memory one or more cached content segments, which encompass a playback period of the requested content segment but differ in media quality level from the requested content segment. The method may include serving the one or more cached content segments regardless of the difference in media quality level. Additionally or alternatively, the method may include converting the one or more cached content segments to the media quality level specified in the request, and then serving the one or more converted content segments.

In some embodiments, the method includes delaying serving of one or more of the retrieved content segments, so as to control a media quality level to be requested for subsequent content segments. Delaying the serving may include estimating a media quality level with which the content segments can currently be fetched remotely to the user device, and delaying the serving so as to cause the estimated media quality level to be requested. In an embodiment, prefetching the content segments includes predicting a media quality level that will be applicable during a future request for one or more future content segments, and prefetching the future content segments having the predicted media quality level.

In another embodiment, prefetching the content segments includes retrieving the content segments with respective media quality levels that decrease with playback start time. In yet another embodiment, retrieving the content segments includes, in response to identifying an imminent transition from a first media quality level to a second media quality level at a predefined location in a subsequent content segment, constructing and serving a hybrid content segment which is encoded with the first media quality level up to the predefined location and with the second media quality level after the predefined location.

There is additionally provided, in accordance with an embodiment of the present invention, an apparatus including an interface for communicating over a network, and a processor. The processor is configured to identify prefetching over the network of one or more content segments of a content item, which includes multiple content segments and an index that specifies storage locations of the content segments, to a memory of a user device, and to modify the index to indicate that the prefetched content segments are to be retrieved from the memory of the user device.

There is also provided, in accordance with an embodiment of the present invention, a method including prefetching to a memory of a user device, over a network, at least part of a content item. Using a software module installed in the user device, a request to retrieve a portion of the content item is intercepted. The portion of the content item is delivered in response to the request using the software module, by: upon finding that the portion belongs to the prefetched part of the content item, serving the portion from the memory of the user device, and, when the portion does not belong to the prefetched part of the content item, fetching the portion over the network. In some embodiments, the content item further includes an index file that specifies storage locations of the content segments, and the requested portion includes either a content segment or a section of the index file.

There is further provided, in accordance with an embodiment of the present invention, a user device including a memory, an interface for communicating over a network, and a processor. The processor is configured to prefetch to the memory of the user device, over the network, at least part of a content item, to intercept a request to retrieve a portion of the content item, and to deliver the portion in response to the request by: upon finding that the portion belongs to the prefetched part of the content item, serving the portion from the memory of the user device, and, when the portion does not belong to the prefetched part of the content item, fetching the portion over the network.

There is additionally provided, in accordance with an embodiment of the present invention, a computer software product, the product including a tangible non-transitory computer-readable medium in which program instructions are stored, which instructions, when read by a processor, cause the processor to identify prefetching over a network of one or more content segments of a content item, which includes multiple content segments and an index that specifies storage locations of the content segments, to a memory of a user device, and to modify the index to indicate that the prefetched content segments are to be retrieved from the memory of the user device.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a content delivery system, in accordance with an embodiment of the present invention;

FIG. 2 is a diagram that schematically illustrates an indexed content item, in accordance with an embodiment of the present invention;

FIG. 3 is a diagram showing modification of an index file in an indexed content item, in accordance with an embodiment of the present invention; and

FIG. 4 is a flow diagram that schematically illustrates a method for delivery of an indexed content item, in accordance with an embodiment of the present invention.

### DETAILED DESCRIPTION OF EMBODIMENTS

### Overview

Some applications and multimedia protocols use indexed content items. An indexed content item comprises multiple content segments, plus an index that specifies storage locations from which the segments are to be retrieved. One common example of an indexed content item is a Hypertext Transfer Protocol Live Streaming (HLS) item used for multimedia streaming.

A typical HLS item comprises one or more sets of content segment files that are encoded at respective encoding rates. Each encoding rate is characterized by a certain media quality level. The HLS item further comprises a respective index file for each set (i.e., for each rate) and optionally a master index file.

A consuming application, such as a media player, typically retrieves content segments for playback by querying the index and accessing the storage locations specified therein.

Embodiments of the present invention that are described herein provide improved methods and systems for delivering indexed content items to user devices that employ prefetching. In some disclosed embodiments, a user device fetches HLS content from a content source over a network, and delivers the content to the user-device media player or other consuming application. In order to improve performance and enhance user experience, the user device employs partial prefetching, i.e., prefetches one or more of the content segments to a local cache before the segments are requested by the media player.

In some embodiments, the user device or the content source modifies the index of the HLS item, so that the index continuously reflects the storage locations of the prefetched segments. In an example embodiment, upon prefetching a segment, the index is modified to specify the storage location of the prefetched segment in the user-device cache. For non-prefetched segments, the index continues to point to the original storage locations of the segments outside the user device (e.g., on the content source).

When querying the modified index, the media player will transparently fetch prefetched segments from the cache, and non-prefetched segments over the network. Thus, the disclosed technique enables the user device to enjoy the full benefit of prefetching when consuming indexed content items. No changes are needed in the media player to support this scheme.

Various related techniques and improvements are also described. Although the embodiments described herein refer mainly to HLS items, the disclosed techniques are applicable in a similar manner to other types of indexed content.

### System Description

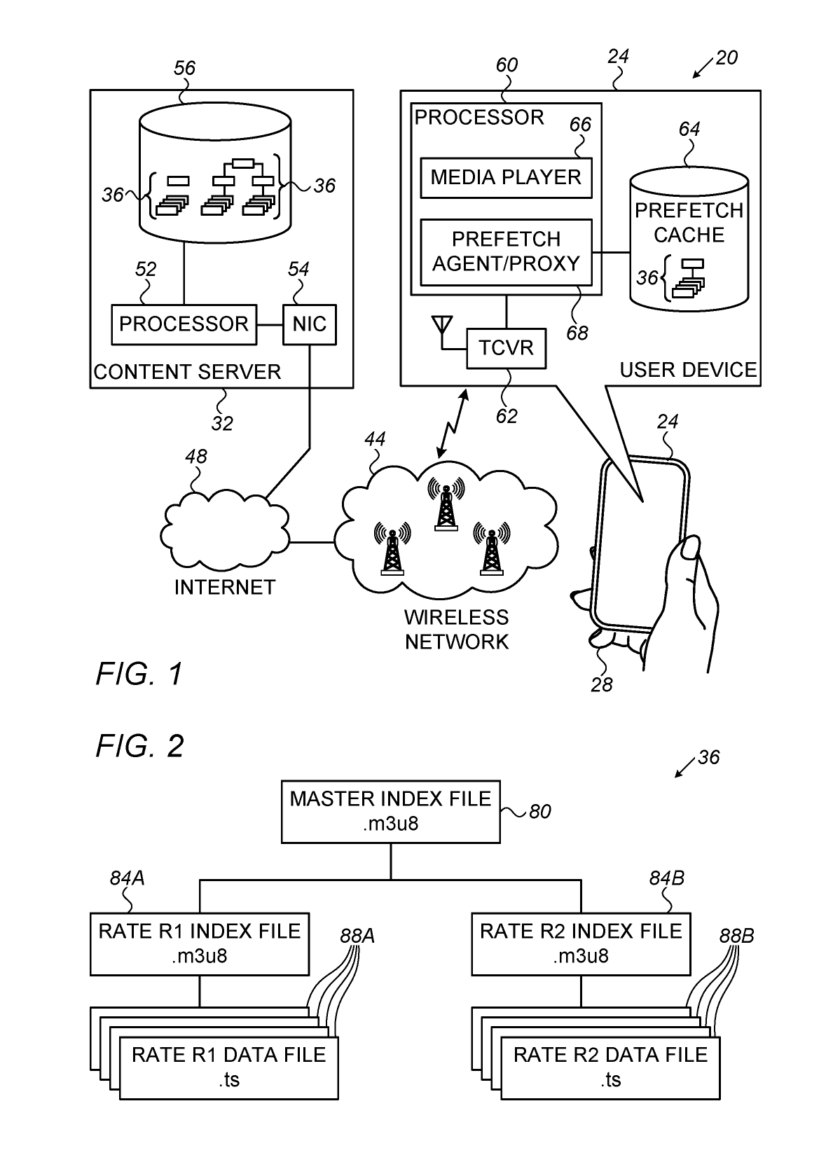

FIG. 1 is a block diagram that schematically illustrates a content delivery system 20, in accordance with an embodiment of the present invention. System 20 comprises a user device 24 that is operated by a user 28. User device 24 accesses and consumes content items provided by one or more content sources, in the present example a content server 32.

User device 24 may comprise any suitable wireless or wireline terminal, such as, for example, a cellular phone or smart-phone, a wireless-enabled laptop or tablet computer, a desktop personal computer, or any other suitable type of user terminal that is capable of communicating over a network and presenting content to a user. User device 24 may consume content using any suitable software, e.g., a browser, a media player or a dedicated application. The figure shows a single user device 24 and a single content server 32 for the sake of clarity, but real-life systems typically comprise a large number of user devices and content sources of various kinds.

User device 24 consumes the content by communicating with content server 32 over a network, in the present example a combination of a wireless (e.g., cellular) network 44 and a Wide-Area Network 48 such as the Internet. Alternatively, the network connecting device 24 and server 32 may comprise, for example, the Internet, a Local Area Network (LAN), a wireless network such as a cellular network or Wireless LAN (WLAN), or any other suitable network or combination of networks.

User device 24 may retrieve and present various types of content to user 28. In some embodiments, device 24 retrieves and presents indexed content items 36 that are stored on content server 32. An indexed content item comprises multiple content segments and an index that specifies the storage locations of the segments. One common example of an indexed content item is Hypertext Transfer Protocol Live Streaming (HLS) video.

In particular, device 24 may prefetch parts of an indexed content item 36 to its local memory, in order to reduce latency and enhance the user experience. Example techniques for efficient prefetching and consumption of indexed content items are described in detail below. Certain aspects of content prefetching, and content prefetching schemes that can be used by device 24 and content server 32, are addressed in U.S. patent application Ser. No. 14/691,597, which is assigned to the assignee of the present patent application and whose disclosure is incorporated herein by reference.

In the example of FIG. 1, content server 32 comprises a Network Interface Controller (NIC) 54 or other suitable network interface for communicating over the network, a processor 52 that carries out the various processing tasks of the server, and one or more storage devices 56 that store indexed content items 36.

In the present example, user device 24 comprises a processor 60 that carries out the various processing tasks of the device, a wireless transceiver 62 (e.g., cellular modem) for communicating over the network, and a prefetch cache memory 64 for caching prefetched content items 36 or parts thereof. Cache 64 is also referred to herein as a local memory. Transceiver 62 is regarded as a kind of network interface for connecting device 24 to the network. In alternative embodiments, e.g., when device 24 is a wireline device that connects to a wired network, any other suitable interface, such as a NIC, can be used.

Among other tasks, processor 60 of device 24 runs a software component referred to as a prefetching agent 68, which handles prefetching of content items. In the present example, processor 60 further runs a media player (or other suitable application) for presenting content to user 28. Alternatively, media player 66 (or other consuming application) may run on a different processor, e.g., a dedicated core or hardware accelerator.

The configurations of system 20 and its various elements shown in FIG. 1 are example configurations, which are chosen purely for the sake of conceptual clarity. In alternative embodiments, any other suitable configurations can be used. Although the embodiments described herein refer mainly to human users, the term “user” refers to machine users, as well. Machine users may comprise, for example, various host systems that use wireless communication, such as in various Internet-of-Things (IoT) applications.

The different elements of system 20 may be implemented using suitable software, using suitable hardware, e.g., using one or more Application-Specific Integrated Circuits (ASICs), Field-Programmable Gate Arrays (FPGAs), dedicated processor or hardware accelerators, or using a combination of hardware and software elements. Cache 64 in device 24 may be implemented using one or more memory devices of any suitable type, e.g., RAM or Flash devices. Storage devices 56 in server 32 may comprise, for example, one or more magnetic or solid-state disks.

In some embodiments, processor 52 and/or processor 60 may be implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Download and Consumption of Indexed Content Items

As noted above, in some embodiments used device 24 retrieves and consumes indexed content items 36. The embodiments described herein refer mainly to HLS items and to video streaming using the HLS protocol, cited above. Alternatively, however, the disclosed techniques can be used, mutatis mutandis, with any other suitable type of indexed content items.

FIG. 2 is a diagram that schematically illustrates an example HLS item 36, in accordance with an embodiment of the present invention. In accordance with the HLS protocol, item 36 stores a multimedia stream (e.g., a video) that has been source-encoded (compressed) at one or more rates. Item 36 comprises a master index file 80, one or more rate-specific index files 84, and multiple content segment files 88.

The index files normally have extensions “.m3u” or “.m3u8”, and the content segment files normally have the extension “.ts”. The index files are also referred to herein as indices or playlists. The content segment files are also referred to herein as data files, segment files or simply segments.

In the example of FIG. 2, item 36 stores the video at two rates denoted R1 and R2. As such, item 36 comprises an index file 84A and multiple segments 88A for rate R1, and an index file 84B and multiple segments 88B for rate R2. Generally, HLS item 36 may support any suitable number of rates. When only a single rate is supported, index file 84 may be omitted, in which case all indexing information is stored in master index file 80.

Each encoding rate is characterized by a certain respective media quality level. The description that follows refers mainly to encoding rates. The disclosed techniques, however, can be used with any other type of indexed content item comprising multiple sets of content segments, which pertain to the same content but differ in media quality level.

Each segment 88 comprises a portion of the multimedia content encoded at the appropriate rate. Typically, all segments comprise the same fixed predefined playback duration (e.g., ten seconds). Corresponding segments that comprise the same content at different rates are typically set to have the same start and end times.

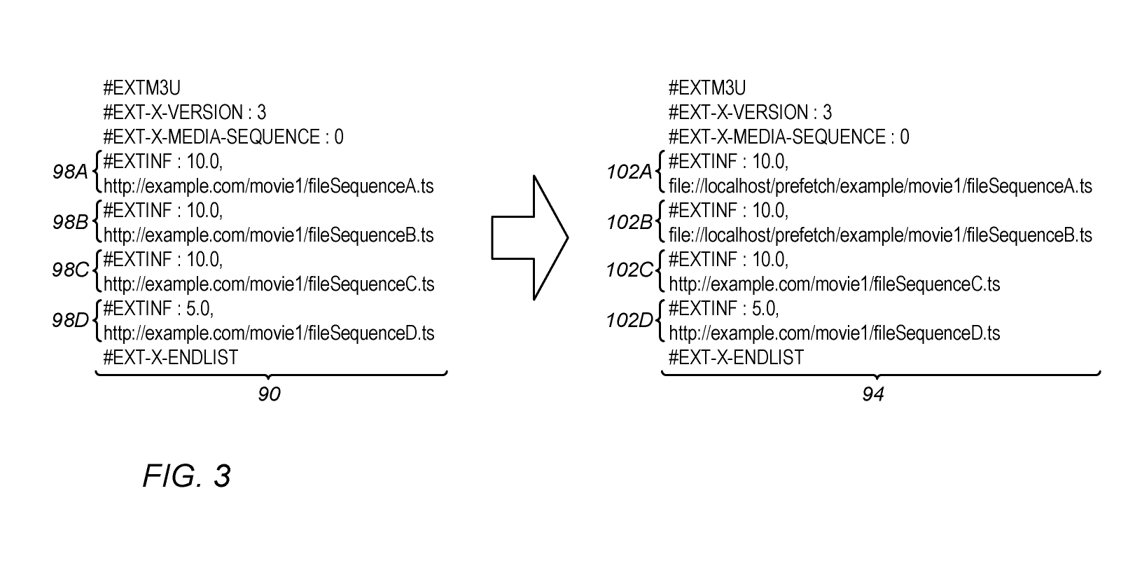

For a given rate, index file 84 comprises multiple entries that specify the storage locations of segment files 88 of that rate. The storage locations may be specified, for example, as Uniform Resource Indicators (URIs) or Uniform Resource Locators (URLs). An example of an index file is shown in FIG. 3 below. In an example embodiment, when all segments 88 of HLS item 36 are stored on server 32, the URLs in the entries of index files 84 will point to locations on storage devices 56. Generally, however, the URLs may point to any suitable storage location that can be accessed by user device 24.

An HLS item is typically consumed and played to user 28 by media player 66. In a typical playback session, media player 66 first downloads the index file or files. The media player then selects the appropriate rate depending on the available bandwidth, typically the highest rate (and thus highest quality) that does not exceed the available bandwidth.

The media player then begins to download and play (present) successive segments of the HLS item at the selected rate. To retrieve a given segment, the media player queries the index file for the URI/URL of that segment, and then downloads the segment from the URI/URL specified in the index file.

Typically, media player 66 has a local buffer that is used for buffering the downloaded content between download and playback. If the available bandwidth changes, e.g., due to a change in channel conditions, the media player may start downloading segments of a different rate.

### Partial Prefetching of Indexed Content Items

In some embodiments, prefetch agent 68 in user device 24 prefetches content from server 32 to cache 64 before the content was actually requested. In the context of HLS items, the term “prefetching” refers to agent 68 fetching one or more content segments 88 before media player 66 (or other application that consumes content) in device 24 has requested these segments. Prefetched segments may not always be consumed. For example, the user may stop viewing the video stream, or the media player may start requesting segments of a different rate.

Thus, at a given point in time, one or more segments 88 of a given HLS item 36 may have been prefetched to cache 64 in device 24, while one or more other segments of the same HLS item may be found only on server 32 (or elsewhere outside device 24) and not in cache 64. In some embodiments of the present invention, processor 60 in device 24, or processor 52 in server 32, modifies index file 84 of this HLS item to account for the prefetching operation. The entries of the modified index file point to storage locations in cache 64 when appropriate (for segments that have been prefetched) and to storage locations in server 32 or elsewhere when appropriate (for segments that have not been prefetched).

FIG. 3 is a diagram showing modification of index file 84, in accordance with an embodiment of the present invention. The left-hand-side of the figure shows the index file in its initial format 90, before any prefetching has been performed. Aside from general metadata, the index file comprises a list of entries 98, each entry 98 specifying a respective content segment 88. The present simplified example has four entries 98A, . . . , 98D, corresponding to four segments.

Each entry 98 has a header (beginning with “*EXTINF:”) that specifies the playback time of the segment, and a URL that specifies the storage location from which the actual content of the segment should be retrieved. In the present example, all segments are stored in the same directory (“movie1”) of the same domain (“http://example.com/”). Generally, however, the segments of a given HLS item may be stored in different locations, and the URLs may specify any suitable storage locations that are accessible to media player 66.

The right-hand-side of FIG. 3 shows the index file in an example modified format 94, after the first two segments 88 have been prefetched by agent 68 to cache 64. The modified index file comprises a list of entries 102A, . . . , 102D. Entries 102A and 102B correspond to segments that have been prefetched. Therefore, the URLs in these entries have been modified to specify local addresses in cache 64 of device 24 (“file://localhost/prefetch/”). The content segment files themselves (“fileSequenceA.ts” and “fileSequenceB.ts”) are identical to the corresponding files stored on the content server. The remaining entries (102C and 102D), which correspond to segments that have not been prefetched, remain the same as in the initial unmodified format 90.

Modifying the index file in this manner enables media player 66 to consume the content (e.g., play the video) while fully exploiting the benefits of prefetching. When querying the modified index file, the media player obtains local URLs (in device 24) for prefetched segments, and remote URLs (outside device 24) for segments that were not prefetched.

The media player will therefore retrieve prefetched segments from cache 64 (served by agent 68), and non-prefetched segments over the network (served by content server 32). This process is typically transparent to the media player, and does not require any modification in the media player. In other words, the media player is typically unaware of the fact that some segments are served locally from the cache and others are retrieved over the network.

In some embodiments, modification of the index file is performed by processor 60 of user device 24, e.g., by prefetch agent 68. In these embodiments, upon prefetching a segment 88 to cache 64, agent 68 modifies the appropriate entry in the appropriate index file to reflect the local storage location of that segment. In these embodiment, the index file itself is typically prefetched to cache 64, as well.

In alternative embodiments, modification of the index file is performed by processor 52 of content server 32. In these embodiments, processor 52 typically stores multiple copies of a given index file, e.g., a copy per user device that accesses the index file, because different user devices typically prefetch different segments at different times. More efficient storage schemes can also be contemplated, e.g., storing a small set of index files (i.e., less than one index file per user device), and a data structure that maps each user device to the index file it uses. In these embodiments, the index file itself may or may not be prefetched to cache 64.

The description that follows refers mainly to the former solution, i.e., modification of the index file by processor 60 in user device 24. This solution may be preferable, e.g., because processor 60 is often in a better position than processor 52 to decide which segments were prefetched and which were not. Moreover, some content providers introduce some user specific attributes into the filenames of the segments in the index file. Processor 60 becomes aware of these attributes when downloading the actual files, but processor 52 may not. Nevertheless, the disclosed techniques can also be used in configurations in which the modification is performed by the content server.

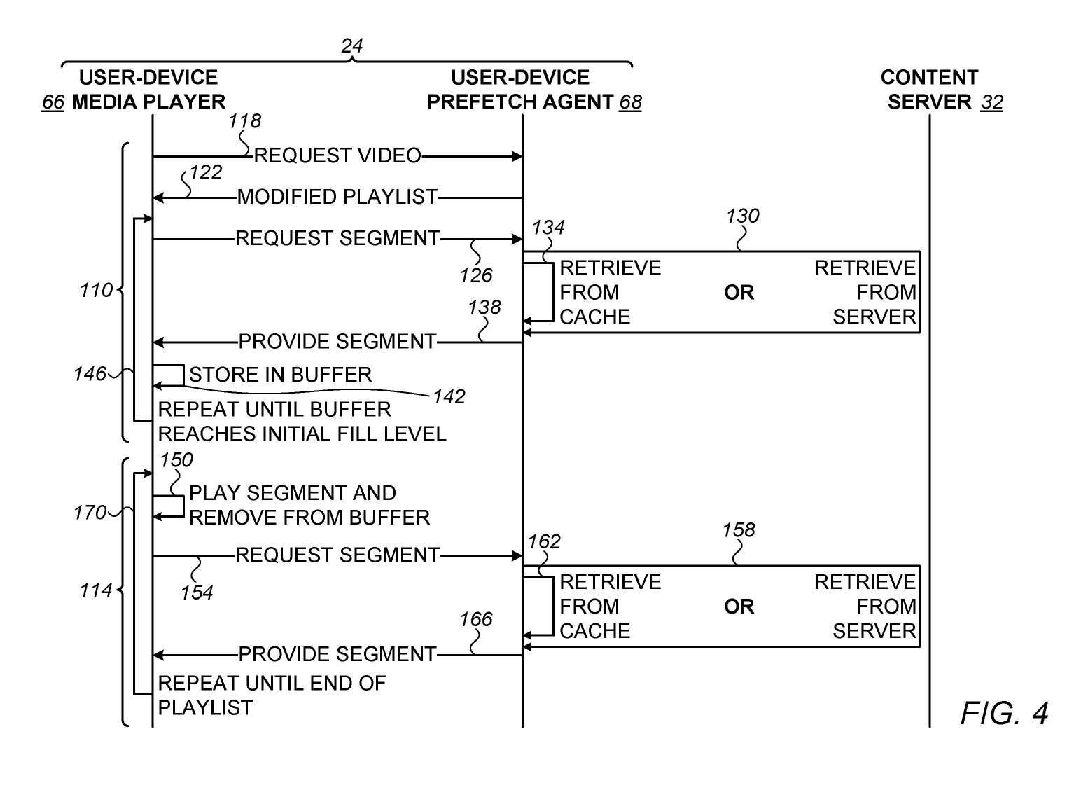

FIG. 4 is a flow diagram that schematically illustrates an example process of streaming a video that is stored in an HLS item 36 to device 24, in accordance with an embodiment of the present invention.

The process is generally divided into an initialization phase 110 and a playback phase 114. In the initialization phase, media player 66 prepares to play the video and ensures that its internal buffer is sufficiently full to begin playback. In the playback phase the media player plays content from the buffer, and in parallel fetches subsequent segments. Both phases support prefetching of segments using a modified index file, as described above.

The method begins with media player 66 requesting to start streaming the HLS item in question, typically in response to a request from user 28, at a video requesting step 118. Agent 68 responds to the request by providing media player 66 with the modified playlist (modified index file), at a playlist sending step 122.

Media player 66 then begins a process of initially filling its buffer with content segments. This initial stage is important for preventing stalls during subsequent playback. At a segment requesting step 126, player 66 requests the next content segment.

Prefetch agent 68 queries the modified playlist and finds out whether the requested segment has been prefetched or not. If, in accordance with the modified playlist, the segment has not been prefetched, agent 68 retrieves the segment over the network from content server 32, at a network retrieval step 130. If, on the other hand, the modified playlist indicates that the segment has been prefetched, agent 68 retrieves the segment locally from cache 64, at a local retrieval step 134. (Note that steps 130 and 134 may alternatively be carried out by media player 66 using the modified playlist provided by agent 68.)

In either case, agent 68 retrieves the segment by accessing the URL (local or remote) specified in the entry of that segment in the modified playlist. Agent 68 provides the retrieved segment to media player 66, at a segment serving step 138.

At a buffering step 142, media player 66 stores the segment in its buffer. The process of steps 126-142 is repeated until the media player buffer is sufficiently full to begin playback. Thus, if the buffer is not yet sufficiently full, the method loops back to step 126 above (loopback marked 146).

In an example embodiment, playback may begin once the buffer holds content equivalent to between 10-20 seconds of playback time. Alternatively, however, any other suitable threshold can be used.

Playback phase 114 begins with media player 66 playing the next buffered segment, at a playback step 150. Player 66 removes the played segment from the buffer, so as to free space for new segments. At a requesting step 154 (which may be performed in parallel to playback) the media player requests the next segment that is not yet buffered.

As in the initialization phase, agent 68 queries the modified playlist and finds out whether the requested segment has been prefetched or not. If, in accordance with the modified playlist, the segment has not been prefetched, agent 68 retrieves the segment over the network from content server 32, at a remote retrieval step 158. If, on the other hand, the modified playlist indicates that the segment has been prefetched, agent 68 retrieves the segment locally from cache 64, at a local fetching step 162.

In either case, agent 68 retrieves the segment by accessing the URL (local or remote) specified in the entry of that segment in the modified playlist. Agent 68 provides the retrieved segment to media player 66, at a segment providing step 166.

The process of steps 150-166 is repeated until the media player buffer is empty and all the segments in the playlist have been retrieved (locally or remotely) and played. Until these conditions are met, the method loops back to step 150 above (loopback marked 170).

As can be appreciated, the disclosed technique enhances user experience considerably, especially when channel conditions are poor and the available bandwidth is low. Local serving of prefetched segments at the initialization phase shortens the start delay of viewing the video considerably: The media player is able to fill its buffer and begin playback almost instantly once the video is requested by the user. At the playback phase, local serving of prefetched segments reduces the likelihood of stalls and improves the robustness and smoothness of viewing the video.

In some embodiments, agent 68 in device 24 may function also as a proxy that receives traffic requests sent by media player 66 and handles the traffic requests in accordance with some predefined policy. In some embodiments, agent 68 modifies the index file so that the entry of a content segment that was prefetched points to a URI/URL of the proxy. Agent 68 may modify the index file, for example, when prefetching the index file or when delivering the index file to the media player.

For example, in the playlist of FIG. 3, when the first segment is prefetched, agent 68 may modify the first entry 98A in the playlist to be http://127.0.0.1:4545/http://example.com/movie1/fileSequenceA.ts, wherein http://127.0.0.1 refers to the local host, and 4545 is the port number used by the proxy (in agent 68) for capturing HTTP requests.

In this embodiment, the decision whether to serve a requested resource (segment or index file) from cache 64 or over the network is made by the proxy in agent 68. Upon capturing a request for a resource sent from media player 66, the proxy checks whether the resource in question has been prefetched and is available in cache 64. If so, the proxy serves the resource to the media player locally from the cache. Otherwise, the proxy retrieves the resource over the network. In an alternative embodiment, agent 68 functions as a proxy as described above, but the modification of the index file is performed by content server 32. In the latter embodiment, the server typically needs to be aware of the user device proxy port.

Implementations that use a proxy enable modifying all the entries of the index file in a similar manner, regardless of whether segments have been prefetched or not. Such an implementation may be simpler to implement.

In alternative embodiments, the proxy in agent 68 is able to intercept normal content requests from media player 66, even when the requests indicate storage locations external to the user device. This capability may depend, for example, on the operating system of the user device and on the proxy implementation. In such embodiments, the proxy in agent 68 may serve requested content segments from cache 64 or over the network as appropriate, without having to modify the index file. In other words, the storage locations specified in the index file all specify remote storage locations outside the user device, even though some content segments may have been prefetched.

In an example embodiment of this sort, the proxy in agent 68 intercepts requests from media player 66 to consume various content segments. For each intercepted request, the proxy checks whether the requested segment has been prefetched or not. If the segment has been prefetched, the proxy serves the prefetched segment from cache 64. Otherwise, the proxy serves the prefetched segment over the network. As noted above, this technique can be carried out without having to modify the index file in any way.

The approach above can also be applied when the content item in question does not comprise an actual index file. In this embodiment, the proxy in agent 68 intercepts requests from media player 66 to consume a portion of the content corresponding to an index or address into a content item, e.g., content file. For each intercepted request, the proxy checks whether the requested portion has been prefetched or not. If the portion has been prefetched, the proxy serves the prefetched portion from cache 64. Otherwise, the proxy serves the prefetched portion over the network.

In some embodiments, the partial prefetching of content proposed herein is applied to content needed to support a good initial user experience. Thus, in many cases this technique would be used for delivering an initial or beginning portion of the content to the user device, so that the user can begin to access the content without delay. In some cases, however, the technique can also be used for delivering other portions of the content. For example, in some cases of the MP4 video format, metadata needed by the media player in order to begin playing the video is available only at the end of the MP4 file. In such a case, the prefetch operation may transfer and cache both a portion of the beginning of the MP4 file and a portion of the end of the file. As another example, if the prefetch policy identifies that certain users who view a particular video are likely to immediately jump to a specific point in the video (e.g., in the middle of the video) then the prefetch operation may obtains a portion of the video that begins at that point in the video.

In many cases, the prefetch policy specifies how much of a content item needs to be downloaded in order to enable uninterrupted access. For example, in the case of streaming media such as HLS, if the available transfer rate is too low, the media player will run out of video to play at some point, and the display will stall until sufficient additional content is buffered. Thus, the amount of streaming content to prefetch may also be based on the estimated amount of content needed to ensure a smooth viewing experience, given the wireless link conditions (i.e., data transfer conditions) expected at the time of content access.

Although the embodiments described herein refer mainly to streaming video (e.g., HLS), the disclosed techniques are applicable to various other applications as well, such as audio files, gaming files, and virtual reality files. The disclosed techniques can also be applied to presentations or word-processing documents, such as PowerPoint or Microsoft Word documents. In such cases, an initial portion of a document could be prefetched so that a subsequent access request would enable the user to immediately access an initial portion of the content (e.g., the first few slides of a presentation document) without delay. In other embodiments, the initial prefetch might comprise only a partial subset of the content items embedded in the document. For example, the initial prefetch of a presentation document might exclude all images above a certain size. In this case, the user might still be able to begin accessing the document without delay and enjoy an excellent user experience, despite initially lacking a few large embedded content items (which could be fetched in real-time and displayed when available).

### Additional Embodiments and Variations

In some embodiments, when the index file supports two or more encoding rates, agent 68 may prefetch a given content segment in more than one rate (i.e., prefetch two or more segment files, encoded at different rates, all corresponding to the same playback start and end times). This technique increases the likelihood that the media player will request the segment at a rate that has been prefetched and cached. In an example embodiment, agent 68 prefetches a given segment in all available rates, so that it is able to serve the segment at any requested rate from cache 64.

In some protocols and/or media player implementations, the order of appearance of the different encoding rates in master index file 80 determines the rate at which the media player will initially attempt to retrieve and play the video. In these embodiments, media player 66 will typically request the first segments for playback at the rate that appears first in the master index file.

In some embodiments, agent 68 exploits this feature and modifies the order of appearance of the rates in the master index file. In this manner agent 68 is able to control the first rate at which the media player will attempt to retrieve and play the HLS item. In addition, agent 68 may prefetch one or more initial segments at the rate that appears first in the modified master index file (and is thus known to be requested first by the media player). Agent 68 may select the rate to appear first using any suitable criterion, e.g., based on a current estimate of the channel quality or available bandwidth.

In other protocols and/or media player implementations, media player 66 requests the first segment of the video at the lowest rate appearing in the master index file. The media player then monitors the time duration needed for obtaining the first segment and, depending on the result, may request the same segment at a higher rate. Subsequent requests for subsequent segments typically depend on the time durations needed to obtain previous segments.

Thus, in some embodiments, agent 68 prefetches the first segment of the video at the lowest rate and thus lowest media quality level) and at the highest rate (and thus highest media quality level) appearing in the master index file. The lowest rate will typically be requested by the media player by default. Since the lowest-rate segment will be served from the cache, the response to this initial request will be fast, and the next request from the media player will most likely to be for the same segment at the highest rate. The second segment may be prefetched by the media player only at the highest rate, since previous responses were fast, and the media player will most likely continue to request segments at the highest rate.

In some embodiments, agent 68 serves media player 66 a segment that differs in rate from the segment requested by the media player. For example, in response to a request for a given segment file, agent 68 may find that cache 64 holds another segment file for the same playback period (same start and end times) but at a different rate. Instead of fetching the requested segment over the network, agent 68 may decide to serve the media player with the available cached segment, notwithstanding the different rate. Typically although not necessarily, agent 68 will serve a cached segment only if its rate (and thus its quality) is higher than that of the requested segment. In an example implementation, agent 68 may modify all the corresponding entries rate-specific index files 88 to point to the same cached segment.

In yet another embodiment, agent 68 may control the encoding rate requested by media player 66 by deliberately delaying one or more of the responses (e.g., served segments) destined to the media player. Typically, upon experiencing a large delay in response, the media player will tend to request segments having a lower encoding rate. Using this technique, agent 68 is able to cause the media player to request prefetched segments that are available in cache 64.

In some embodiments, agent 68 may predict the channel conditions, and thus the encoding rate that will be applicable at the time a subsequent segment will need to be fetched over the network. Based on this prediction, agent 68 may choose to prefetch segments having the predicted encoding rate. Assuming adequate prediction, this technique provides smooth playback quality and thus improved user experience. The rate prediction may be based, for example, on measurements performed in the distant past under similar conditions to the present conditions, or on recent measurements performed during consumption of other content items.

In other embodiments, agent 68 may estimate the current channel condition, and thus the encoding rate, that is applicable at the time media player 66 requests a segment. Depending on this estimation, agent 68 may deliberately delay one or more of its responses to the media player during actual playback. The delay will cause the media player to request segments that will be fetched over the network with the estimated encoding rate.

In some embodiments, in response to a request for a segment by media player 66, agent 68 finds a cached segment that corresponds to the same playback time (same start and end time) but with a different rate than requested. Agent 68 responds to the request by converting the content of the cached segment to the requested rate, and then serves the content at the requested rate to the media player. A similar approach can also be applied when agent 68 finds a cached segment that is longer than the requested segment but encompasses the playback period of the requested segment (i.e., a cached segment that starts earlier and/or ends later than the requested segment). In yet another embodiment, agent 68 may find two or more segments that together encompass the playback period of the requested segment, but have a different rate than requested. Agent 68 may respond to the request by converting the content of these cached segments to the requested rate, and serve the content at the requested rate to the media player.

In some embodiments, when using the above technique, agent 68 prefetches segments only at a predefined subset of the supported rates (e.g., only at the one or more highest rates). Upon receiving from media player 66 a request for a segment at a different rate (e.g., a lower rate), agent 68 converts the content of a cached segment from the high (available) rate to the lower (requested) rate, and serves the content to the media player.

In yet another embodiment, agent 68 prefetches content segments at encoding rates that decrease as a function of the playback start time. Consider, for example, a video represented by four sets of segments having four respective rates, each set comprising forty segments. Agent 68 may prefetch segments one to ten at the highest rate, segments eleven to twenty at the second highest rate, segments twenty-one to thirty at the third highest rate, and segments thirty-one to forty at the fourth highest (lowest) rate.

With this form of prefetching, the video will start playing at the highest rate. If the actual channel conditions are better than the second highest rate, segments eleven to forty will be fetched from the network, otherwise segments eleven to twenty will be fetched from cache 64. Similarly, if the channel conditions after segment twenty are better than the second highest rate, segments twenty-one to thirty will be fetched from the network, otherwise segments twenty-one to thirty will be fetched from cache 64. Overall, this mechanism provides a trade-off between the amount of prefetching and the probability that the media player will experience stalls.

In some cases, HLS content segments are not fully aligned with the video structure used by media player 66. For example, a typical content segment may hold ten seconds of playback time, while a typical video may be encoded with anchor frames (also referred to as Intra-Frames or I-Frames) spaced three seconds apart. Anchor frames are used as an initial image from which subsequent video images are calculated differentially. Anchor frames are used by media player 66 as a switching point between different encoding rates. Since the ten-second segment duration is not an integer multiple of the three-second anchor frame spacing, rate switching may occur in the middle of a segment. In such cases, the media player typically requests the content segment at two rates (the rates before and after the switching point). The media player then plays the content from the first segment up to the switching point (until the anchor frame) and then starts playing the content from the second segment.

In some embodiments, agent 68 keeps track of the segments already provided to the media player, and is also aware of the locations of anchor frames in the segments. This awareness can be deduced indirectly from the media player activity, or using explicit signaling from the media player to agent 68. In an embodiment, upon detecting that the media player requests a segment that was already provided to it but at a different rate, agent deduces that the media player prepares to switch to the new encoding rate during this segment.

In response, agent 68 fetches over the network (at the new rate) only the portion of the segment that is subsequent to the anchor frame. Agent 68 then generates a hybrid segment, which comprises content at the old rate up to the anchor frame, and content at the new rate after the anchor frame. The latter content is obtained over the network. The former content is already available since it has been provided to the media player previously. When the hybrid segment is delivered to media player 66, the media player extracts only the content that follows the anchor frame (the switching point), and the video can be played normally with a substantial decrease in required bandwidth.

Although the embodiments described herein mainly address the HLS protocol, the methods and systems described herein can also be used with other multimedia protocols, as well as with other types of indexed content items.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
prefetching to a memory of a user device one or more content segments of a content item, which comprises multiple content segments and an index that specifies storage locations of the content segments;
modifying the index to indicate that the prefetched content segments are to be retrieved from the memory of the user device; and
delivering at least part of the content item by retrieving at least some of the content segments in accordance with the modified index.

2. The method according to claim 1, wherein the content item comprises a HTTP Live Streaming (HLS) item, and wherein the index comprises a playlist of the HLS item.

3. The method according to claim 1, wherein modifying the index comprises, in response to prefetching a given content segment, setting a specified storage location of the given content segment in the index to indicate the storage location of the given content item in the memory of the user device.

4. The method according to claim 1, wherein, at a given point in time, the modified index comprises at least:
a first entry that specifies a first storage location in the memory of the user device, for retrieving a first content segment that has been prefetched to the memory; and
a second entry that specifies a second storage location outside the user device, for retrieving a second content segment that has not been prefetched to the memory.

5. The method according to claim 1, wherein modification of the index is performed by a processor in the user device.

6. The method according to claim 1, wherein modification of the index is performed by a processor in a content source that hosts the content item.

7. The method according to claim 1, wherein retrieving the content segments comprises running in the user device a proxy that retrieves the prefetched content segments from the memory of the user device and retrieves non-prefetched content segments over a network.

8. The method according to claim 7, wherein modifying the index comprises, in response to prefetching a given content segment, setting a specified storage location of the given content segment in the index to point to the proxy.

9. The method according to claim 7, wherein modifying the index comprises setting all specified storage locations of the content segments in the index to point to the proxy, regardless of whether the content segments have been prefetched or not.

10. The method according to claim 1, wherein prefetching the content segments comprises prefetching two or more content segments, which correspond to a same playback period and have different media quality levels.

11. The method according to claim 1, wherein the content item comprises multiple sets of the content segments having different media quality levels, and wherein modifying the index comprises modifying an order of appearance of the sets in the index.

12. The method according to claim 1, wherein prefetching the content segments comprises prefetching one or more initial content segments, which correspond to a beginning of the content item and have the highest and lowest media quality levels appearing in the index.

13. The method according to claim 1, wherein retrieving the content segments comprises, in response to a request to consume a content segment, retrieving from the memory one or more cached content segment, which encompass a playback period of the requested content segment but differ in media quality level from the requested content segment.

14. The method according to claim 13, and comprising serving the one or more cached content segments regardless of the difference in media quality level.

15. The method according to claim 13, and comprising converting the one or more cached content segments to the media quality level specified in the request, and then serving the one or more converted content segments.

16. The method according to claim 1, and comprising delaying serving of one or more of the retrieved content segments, so as to control a media quality level to be requested for subsequent content segments.

17. The method according to claim 16, wherein delaying the serving comprises estimating a media quality level with which the content segments can currently be fetched remotely to the user device, and delaying the serving so as to cause the estimated media quality level to be requested.

18. The method according to claim 1, wherein prefetching the content segments comprises predicting a media quality level that will be applicable during a future request for one or more future content segments, and prefetching the future content segments having the predicted media quality level.

19. The method according to claim 1, wherein prefetching the content segments comprises retrieving the content segments with respective media quality levels that decrease with playback start time.

20. The method according to claim 1, wherein retrieving the content segments comprises, in response to identifying an imminent transition from a first media quality level to a second media quality level at a predefined location in a subsequent content segment, constructing and serving a hybrid content segment which is encoded with the first media quality level up to the predefined location and with the second media quality level after the predefined location.

21. Apparatus, comprising:
an interface for communicating over a network; and
a processor, which is configured to identify prefetching over the network of one or more content segments of a content item, which comprises multiple content segments and an index that specifies storage locations of the content segments, to a memory of a user device, and to modify the index to indicate that the prefetched content segments are to be retrieved from the memory of the user device.

22. The apparatus according to claim 21, wherein the content item comprises a HTTP Live Streaming (HLS) item, and wherein the index comprises a playlist of the HLS item.

23. The apparatus according to claim 21, wherein the processor is configured, in response to prefetching a given content segment, to set a specified storage location of the given content segment in the index to indicate the storage location of the given content item in the memory of the user device.

24. The apparatus according to claim 21, wherein, at a given point in time, the modified index comprises at least:
a first entry that specifies a first storage location in the memory of the user device, for retrieving a first content segment that has been prefetched to the memory; and
a second entry that specifies a second storage location outside the user device, for retrieving a second content segment that has not been prefetched to the memory.

25. The apparatus according to claim 21, wherein modification of the index is performed in the user device.

26. The apparatus according to claim 21, wherein modification of the index is performed in a content source that hosts the content item.

27. The apparatus according to claim 21, wherein the processor is configured to run a proxy that retrieves the prefetched content segments from the memory of the user device, and retrieves non-prefetched content segments over the network.

28. The apparatus according to claim 27, wherein, in response to prefetching a given content segment, the processor is configured to set a specified storage location of the given content segment in the index to point to the proxy.

29. The apparatus according to claim 27, wherein the processor is configured to set all specified storage locations of the content segments in the index to point to the proxy, regardless of whether the content segments have been prefetched or not.

30. The apparatus according to claim 21, wherein the processor is configured to prefetch two or more content segments, which correspond to a same playback period and have different media quality levels.

31. The apparatus according to claim 21, wherein the content item comprises multiple sets of the content segments having different media quality levels, and wherein the processor is configured to modify an order of appearance of the sets in the index.

32. The apparatus according to claim 21, wherein the processor is configured to prefetch two or more initial content segments, which correspond to a beginning of the content item and have the highest and lowest media quality levels appearing in the index.

33. The apparatus according to claim 21, wherein, in response to a request to consume a content segment, the processor is configured to retrieve from the memory one or more cached content segments, which encompass a playback period of requested content segment but differ in media quality level from the requested content segment.

34. The apparatus according to claim 33, wherein the processor is configured to serve the one or more cached content segments regardless of the difference in media quality level.

35. The apparatus according to claim 33, wherein the processor is configured to convert the one or more cached content segment to the media quality level specified in the request, and then to serve the one or more converted content segments.

36. The apparatus according to claim 21, wherein the processor is configured to delay serving of one or more of the retrieved content segments, so as to control a media quality level to be requested for subsequent content segments.

37. The apparatus according to claim 36, wherein the processor is configured to estimate a media quality level with which the content segments can currently be fetched remotely to the user device, and to delay the serving so as to cause the estimated media quality level to be requested.

38. The apparatus according to claim 21, wherein the processor is configured to predict a media quality level that will be applicable during a future request for one or more future content segments, and to prefetch the future content segments having the predicted media quality level.

39. The apparatus according to claim 21, wherein the processor is configured to retrieve the content segments with respective media quality levels that decrease with playback start time.

40. The apparatus according to claim 21, wherein, in response to identifying an imminent transition from a first media quality level to a second media quality level at a predefined location in a subsequent content segment, the processor is configured to construct and serve a hybrid content segment which is encoded with the first media quality level up to the predefined location and with the second media quality level after the predefined location.

41. A method, comprising:
prefetching to a memory of a user device, over a network, at least part of a content item;
using a software module installed in the user device, intercepting a request to retrieve a portion of the content item; and
delivering the portion of the content item in response to the request using the software module, by:
upon finding that the portion belongs to the prefetched part of the content item, serving the portion from the memory of the user device; and
when the portion does not belong to the prefetched part of the content item, fetching the portion over the network.

42. The method according to claim 41, wherein the content item further comprises an index file that specifies storage locations of content segments, and wherein the requested portion comprises either a content segment or a section of the index file.

43. A user device, comprising:
a memory;
an interface for communicating over a network; and
a processor, which is configured to prefetch to the memory of the user device, over the network, at least part of a content item, to intercept a request to retrieve a portion of the content item, and to deliver the portion in response to the request by:
upon finding that the portion belongs to the prefetched part of the content item, serving the portion from the memory of the user device; and
when the portion does not belong to the prefetched part of the content item, fetching the portion over the network.

44. The user device according to claim 43, wherein the content item further comprises an index file that specifies storage locations of content segments, and wherein the requested portion comprises either a content segment or a section of the index file.

45. A computer software product, the product comprising a tangible non-transitory computer-readable medium in which program instructions are stored, which instructions, when read by a processor, cause the processor to identify prefetching over a network of one or more content segments of a content item, which comprises multiple content segments and an index that specifies storage locations of the content segments, to a memory of a user device, and to modify the index to indicate that the prefetched content segments are to be retrieved from the memory of the user device.
